(19) United States
(12) Patent Application Publication
(10) Pub. No.: US 2009/0125319 A1
(43) Pub. Date: May 14, 2009

(54) SYSTEMS, METHODS, AND COMPUTER PROGRAM PRODUCTS FOR ALLOCATING CREDIT BASED UPON DISTRIBUTION OF ELECTRONIC CONTENT

(75) Inventor: Ari Craine, Marietta, GA (US)

Correspondence Address: AT&T Legal Department - CC;Attn: Patent Docketing, Room 2A-207, One AT&T Way, Bedminster, NJ, 07921, US

(73) Assignee: AT&T DELAWARE INTELLECTUAL PROPERTY, INC., Wilmington, DE (US)

(21) Appl. No.: 11/939,810

(22) Filed: Nov. 14, 2007

(51) Int. Cl. G06Q 99/00

(52) U.S. Cl. 705/1

(57) ABSTRACT

Systems, methods, and computer program products are described for allocating credit based upon distribution of electronic content. The methods include distributing an item of electronic content from a distributor to a first recipient; generating a credit tracking message corresponding to the item of electronic content that includes a distributor identifier associated with the distributor; and assigning a first credit score to the distributor using the credit tracking message.

### FIELD OF THE INVENTION

The present invention relates generally to distribution of electronic content and, more specifically, to systems, methods, and computer program products for allocating credit based upon distribution of electronic content.

### BACKGROUND OF THE INVENTION

Various media sharing sites are available on the Internet. In general, these sites allow individual users to post items of electronic content such as movies, audiovisual presentations, and music videos for others to view. The site identifies the individual posting the electronic content by associating a user name, email address, or other identifying indicia with a text-based, graphical, or image-based description of the content. From time to time, other users browse the site, searching through the descriptions of content to select one or more items of interest for subsequent viewing or download. The site maintains a running count of the total number of times that each item has been viewed or downloaded. Accordingly, users browsing the site are able to identify the most popular items of electronic content.

When a user encounters an interesting or noteworthy item of electronic content on a social media sharing site, the user may wish to bring this item to the attention of friends, relatives, colleagues, or other individuals. Illustratively, the user may include a uniform resource locator (URL) link to the item in an email message sent to a group of individuals. Alternatively or additionally, the user may include a copy of the content in the email message, post a URL link to the content on an Internet website, or include a copy of the content on an Internet website.

Under many circumstances, there is significant inherent value in providing widespread distribution of electronic content. Value may be added to the content itself, to an owner of the content, or both. For example, an item of electronic content may include an advertisement for a product or service, a promotion for an upcoming movie or event, an important news update, or critical business information. If an electronic advertisement is widely distributed, this may create robust demand for the product or service being advertised. Therefore, an effective content distributor will provide more intrinsic value to the content owner than an ineffective content distributor. Yet, in contrast to tangible media such as newspapers and magazines, it is difficult to determine the extent to which an item of electronic content is being distributed.

Existing electronic content distribution techniques are capable of measuring the total number of times that an item is downloaded or viewed from a specified Internet website. However, these techniques fail to provide any indication as to how extensively the item of electronic content is being distributed beyond the confines of the specified Internet website. Moreover, these techniques treat all downloads as having the same intrinsic value. One download executed by a highly effective content distributor is treated as being equal to one download executed by a highly ineffective content distributor, even though the highly effective content distributor is adding much more intrinsic value than the ineffective content distributor. For instance, a website might indicate that a given item of electronic content has been downloaded only two or three times, thereby suggesting that the item has not been widely distributed. This indication fails to consider the fact that one of the individuals downloading the item is a highly effective distributor who subsequently places the item into an email message sent to thousands of individuals. Accordingly, what is needed is an improved technique for determining the extent to which an item of electronic content is distributed so as to permit allocating electronic credits to one or more individuals that have distributed the content.

### SUMMARY OF THE INVENTION

Systems, methods, and computer program products are described for allocating credit based upon distribution of electronic content. The methods include distributing an item of electronic content from a distributor to a first recipient; generating a credit tracking message corresponding to the item of electronic content that includes a distributor identifier associated with the distributor; and assigning a first credit score to the distributor using the credit tracking message.

Another set of exemplary embodiments include computer program products for allocating credit based upon distribution of electronic content. The computer program products include a storage medium readable by a processing circuit and storing instructions for execution by the processing circuit for facilitating a method. The method includes distributing an item of electronic content from a distributor to a first recipient; generating a credit tracking message corresponding to the item of electronic content that includes a distributor identifier associated with the distributor; and assigning a first credit score to the distributor using the credit tracking message.

Another set of exemplary embodiments include systems for allocating credit based upon distribution of electronic content. The systems include a distribution server for distributing an item of electronic content from a distributor to a first recipient; the distribution server including a mechanism for generating a credit tracking message corresponding to the item of electronic content that includes a distributor identifier associated with the distributor; and an electronic credit tracking server, operably coupled to the distribution server, for assigning a first credit score to the distributor using the credit tracking message.

Other methods, computer program products, and systems according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a simplified block diagram of an exemplary system for allocating credit based upon distribution of electronic content.

FIG. 2 is a flowchart of an exemplary procedure for allocating credit based upon distribution of electronic content.

FIG. 3 is a data structure diagram setting forth an illustrative credit message for use with the procedure of FIG. 2.

The detailed description explains the exemplary embodiments, together with advantages and features, by way of example with reference to the drawings.

### DETAILED DESCRIPTION OF THE INVENTION

In the following detailed description, numerous specific details are set forth in order to provide a thorough understanding of embodiments. However it will be understood by those of ordinary skill in the art that the embodiments may be practiced without these specific details. In other instances, well-known methods, procedures, components and circuits have not been described in detail so as not to obscure the embodiments.

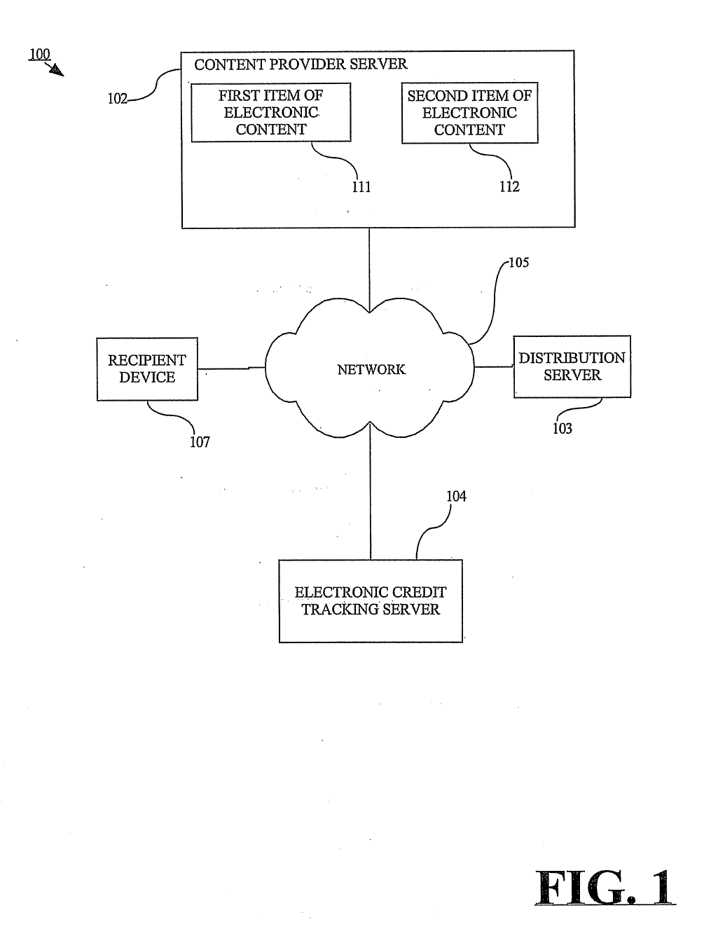

FIG. 1 is a simplified block diagram of an exemplary system 100 for allocating credit based upon distribution of electronic content. System 100 includes a content provider server 102 for storing and distributing at least one item of electronic content, such as a first item of electronic content 111 and a second item of electronic content 112. First item of electronic content 111 illustratively represents an audiovisual presentation, movie, still image, audio clip, advertisement, news item, or any other type of electronic content. Likewise, second item of electronic content 112 illustratively represents an audiovisual presentation, movie, still image, audio clip, advertisement, news item, or any other type of electronic content.

In some embodiments, content provider server 102 allows a distribution server 103 to send first and second items of electronic content 111, 112 to one or more recipient devices such as a recipient device 107. In other embodiments, content provider server 102 does not allow distribution server 103 to send first and second items of electronic content 111, 112 to one or more recipient devices, but only allows distribution server 103 to send recipient device 107 links to first and second items of electronic content 111, 112. If distribution server 103 does not allow sending of first and second items of electronic content 111, 112 to recipient device 107, then recipient device 107 must go back to content provider server 102 by following the links so as to access content 111, 112 according to exemplary embodiments.

Content provider server 102 is operatively coupled to distribution server 103. For example, content provider server 102 could be connected directly to distribution server 103 or, as shown in FIG. 1, content provider server 102 may communicate with distribution server 103 over a network 105. Distribution server 103 is capable of distributing an item of electronic content, such as first item of electronic content 111, in response to a request received from a user or distributor. Distribution server 103 may distribute the item 111 by at least one of: (a) transmitting a link to the item from the distributor to one or more recipients such as a recipient using recipient device 107, (b) transmitting the item or a copy thereof from the distributor to one or more recipients such as a recipient at recipient device 107, (c) incorporating the link into an Internet web page, or (d) incorporating the item, or a copy thereof, into the Internet web page.

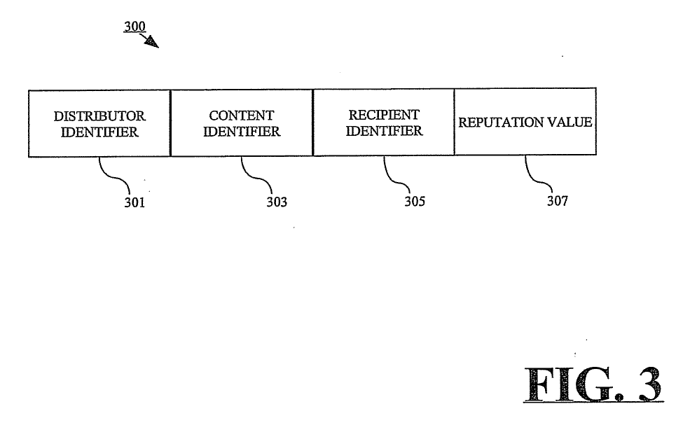

According to exemplary embodiments, distribution server 103 is capable of generating a credit tracking message 300 (FIG. 3). Credit tracldng message 300 may include a distributor identifier 301 associated with the distributor, and one or more of: (a) a content identifier 303 associated with the item 111, (b) one or more recipient identifiers, such as a recipient identifier 305, each of which is associated with a recipient to which the item is to be distributed, or (c) a reputation value 307 associated with the distributor. Content identifier 303 categorizes or identifies an item of electronic content, such as first item of electronic content 111, by associating the item with one or more item types or categories, such as advertisements, movies, audiovisual presentations, news items, still images, educational items, entertainment items, or any of various additional or alternative types or categories, thereby placing the item into a category. A particular item is associated with one or more categories based upon the identity or nature of the item, or based upon manual assignment of the item to one or more categories, or based upon one or more keywords associated with the item. Reputation value 307 will be described in greater detail hereinafter.

An electronic credit tracking server 104 (FIG. 1), operatively coupled to distribution server 103, is capable of receiving credit tracking message 300 (FIG. 3) from distribution server 103 (FIG. 1). Using credit tracking message 300 (FIG. 3), electronic credit tracking server 104 (FIG. 1) may assign a credit score to the distributor. According to exemplary embodiments, the credit score is based upon at least one of the content identifier 303 (FIG. 3) associated with the item 111, a number of recipients to which the item is distributed, or the reputation value 307 associated with the distributor. Electronic credit tracking server 104 could be connected directly to distribution server 103 or, as shown in FIG. 1, electronic credit tracking server 104 may communicate with distribution server 103 over network 105.

In operation, electronic credit tracking server 104 may assign a credit score to a first user representing a distributor in response to the first user sharing an item of electronic content, such as first item of electronic content 111, with a set of second users representing recipients. Subsequently, if the second set of users shares the item 111 with a third set of users, credit tracking server 104 may now consider the second set of users to be distributors with the third set of users representing recipients. Accordingly, credit tracking server 104 will assign credit scores to the second set of users based upon sharing with the third set of users. Optionally, credit tracking server 104 will assign, increment, or adjust the credit score of the first user based upon the second set of users sharing the item with the third set of users. Optionally, a larger weight may be given to distributions of content, as compared with merely providing access to the content when determining a credit score.

Reputation values, such as the reputation value 307, for each of a plurality of distributors may be stored in electronic credit tracking server 104 or distribution server 103 or both. Reputation value 307 (FIG. 3) may be determined or calculated by credit tracking server 104 (FIG. 1) or distribution server 103 (or both) as a function of the number of recipients the distributor knows, the number of recipients who know the distributor, past distribution history for the distributor, a frequency or amount of usage whereby the distributor uses distribution server 103 to distribute electronic content, a rating assigned to the distributor by one or more recipients, a type or category of electronic content that the distributor has previously shared with recipients, or any of various combinations thereof. In some situations, the distributor may represent a programming provider, a collector of content-on-demand, or both. By way of example, the distributor could set up their own radio or television channel that includes links to a plurality of items of electronic content.

A non-exhaustive list of device types or categories that distribution server 103 and recipient device 107 may represent include workstations, mainframe computers, notebook computers, laptop computers, desktop personal computers, personal digital assistants (PDAs), hand-held computers, electronic mail (Email) clients, media presentation devices capable of implementing internet protocol television (IPTV), programmable consumer electronics, networked PCs, cellular telephones, smart cellphones, and the like. Distribution server 103 and recipient device 107 could, for example, be two different devices selected from the foregoing listing, or two of the same devices selected from the foregoing listing.

A non-exhaustive list of device types or categories that content provider server 102 and electronic credit tracking server 104 may represent include mainframe computers, workstations, notebook computers, laptop computers, desktop personal computers, networked PCs, and the like. Content provider server 102 and electronic credit tracking server 104 could, for example, be two different devices selected from the foregoing listing, or two of the same devices selected from the foregoing listing.

A non-exhaustive list of examples for network 105 includes wired or optical networks such as the Internet, intranets, Ethernet networks, token rings, Universal Serial Bus (USB), wired networks according to the IEEE 1394-1995, IEEE 1394a-2000, and IEEE 1394b standards (commonly known as “FireWire”), Direct Sequence—Code Division Multiple Access (DS-CDMA), Global System for Mobile Communications (GSM), North American Digital Cellular (NADC), Time Division Multiple Access (TDMA), Extended-TDMA (E-TDMA), W-CDMA, GPRS, GSM, Enhanced Data for GSM Evolution (EDGE), 3G and 4 G communication, wireless local area networks such as 802.11, Bluetooth™, Zigbee™, ultra wideband (UWB), or any combination thereof. Network 105 may include any combination of additional communication devices (not shown) such as gateways, routers, switches, and the like.

Communications between any of content provider server 102, distribution server 103, electronic credit tracking server 104, recipient device 107 and network 105 may, but need not, take place using an Ethernet, digital subscriber loop (DSL) or cable connection, a third-generation (3G), WiFi, or WiMax mobile access link, wideband code division multiple access (W-CDMA), CDMA2000, global system for mobile (GSM), general packet radio service (GPRS), wireless local area network (WLAN), other wireless or wired protocol, or any of various combinations thereof.

Although FIG. 1 shows content provider server 102, distribution server 103, and electronic credit tracking server 104 as separate elements, this is only for purposes of illustration. One or more of these elements 102, 103, 104 could be implemented using a single element. Moreover, although a single content provider server 102, distribution server 103, recipient device 107, and electronic credit tracking server 104 are shown, it is to be understood that one or more of each of these devices could be present. Finally, network 105 is shown for purposes of illustration, as one or more of content provider server 102, distribution server 103, recipient device 107, or electronic credit tracking server 104 could be connected directly without the need for network 105. Alternatively or additionally, one or more of content provider server 102, distribution server 103, recipient device 107, or electronic credit tracking server 104 may communicate with network 105 using a second network (not shown).

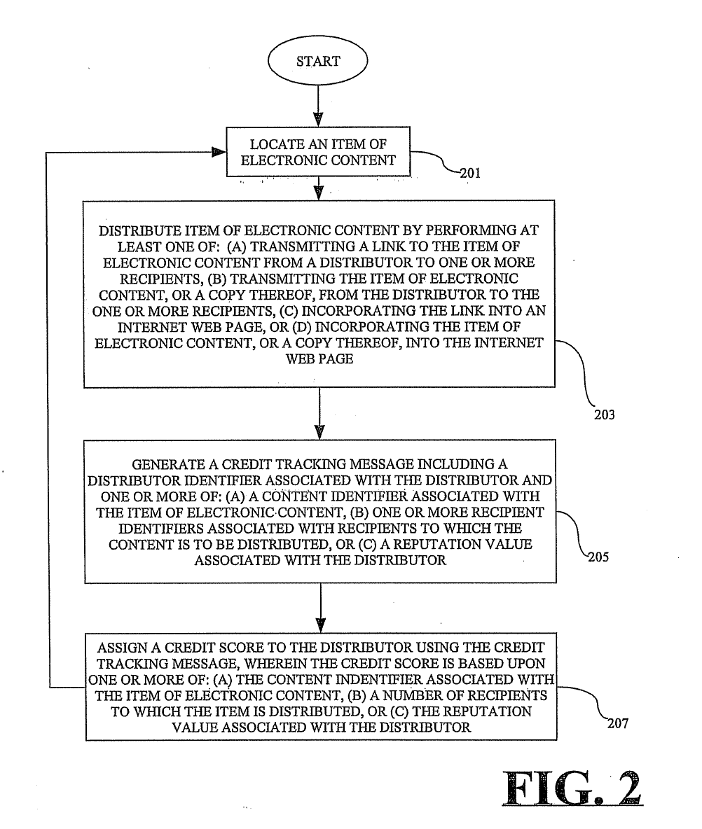

FIG. 2 is a flowchart of an exemplary procedure for allocating credit based upon distribution of electronic content. The procedure commences at block 201 where an item of electronic content is located, such as first item of electronic content 111 (FIG. 1) or second item of electronic content 112. This item 111 may be located by finding the item on the Internet, by viewing or listening to the item, by receiving a link that points to the item, by using a search engine to locate the item, or any of various combinations thereof. Once the item 111 is located, a user (i.e., a distributor) may wish to share (i.e., distribute) the item. Accordingly, at block 203 (FIG. 2), the item 111 is distributed by at least one of: (a) transmitting a link to the item of electronic content from a distributor to one or more recipients, transmitting the item of electronic content itself, or a copy thereof, from the distributor to the one or more recipients, incorporating the link into an Internet web page, or incorporating the item of electronic content, or a copy thereof, into the Internet web page.

Illustratively, transmitting a link to the item 111 from a distributor to one or more recipients may be performed by transmitting the link from distribution server 103 (FIG. 1) to recipient device 107 over network 105. Optionally, distribution server 103 may send the link to one or more recipient devices (not shown) in addition to recipient device 107, wherein these one or more recipient devices are operatively coupled to network 105. Likewise, transmitting the item 111, or a copy thereof, from the distributor to the one or more recipients may be performed by transmitting the item 111 from distribution server 103 to recipient device 107 over network 105. Optionally, distribution server 103 may send the item to one or more recipient devices (not shown) in addition to recipient device 107, wherein these one or more recipient devices are operatively coupled to network 105.

Alternatively or additionally, block 203 (FIG. 2) may be performed by the distributor providing a “share-to” address to distribution server 103 (FIG. 1), wherein the share-to address specifies a destination for which an item of electronic content, such as first item of electronic content 111, is to be shared. More specifically, the share-to address may be used to specify any electronically addressable space. Optionally, a group of share-to addresses may be provided to distribution server 103. In this manner, the distributor is providing a creator of the item of electronic content 111 with greater visibility, providing value to the creator, especially in cases where the content represents advertising.

At block 205 (FIG. 2), a credit tracking message 300 (FIG. 3) corresponding to the distributed item 111 is generated that includes distributor identifier 301. Illustratively, the credit tracking message 300 is sent by the content provider server 102, or by the distribution server 103. As indicated previously, credit tracking message 300 also includes one or more of: (a) content identifier 303 associated with the distributed item of electronic content 111, (b) one or more recipient identifiers associated with recipients to which the content is to be distributed (such as recipient identifier 305), or (c) reputation value 307. The credit tracking message is sent to electronic credit tracking server 104 once it is generated. The credit tracking message is sent automatically in response to distribution of the item, or periodically at predetermined intervals, or in response to a received request for the credit tracking message. Next, at block 207 (FIG. 2), a credit score is assigned to the distributor using credit tracking message 300 (FIG. 3). The credit score is based upon one or more of content identifier 303, recipient identifier 305, or reputation value 307. Illustratively, the credit score is determined by electronic credit tracking server 104 (FIG. 1). Optionally, the credit score may be stored at electronic credit tracking server 104, or downloaded to distribution server 103, or both.

Optionally, the credit score is used to generate a credit score report. For example, credit scores from a plurality of different distributors could be aggregated or combined to generate a credit score report for use by a content owner or a distributor or both. In this manner, the content owner is provided with potentially useful information such as the number of users who considered the content to be worthy of sharing with other users.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of allocating credit based upon distribution of electronic content, the method comprising:
distributing an item of electronic content from a distributor to a first recipient;
generating a credit tracking message corresponding to the item of electronic content that includes a distributor identifier associated with the distributor; and
assigning a first credit score to the distributor using the credit tracking message.

2. The method of claim 1 wherein distributing is performed by at least one of: transmitting a link to the item from a distributor to one or more recipients, transmitting the item, or a copy thereof, from the distributor to the one or more recipients, incorporating the link into an Internet web page, or incorporating the item, or a copy thereof, into the Internet web page; and the credit tracking message further includes one or more of: a content identifier associated with the item, one or more recipient identifiers associated with recipients to which the content is to be distributed, or a reputation value associated with the distributor; and wherein the credit score is based upon at least one of the content identifier associated with the item, a number of recipients to which the item is distributed, or the reputation value associated with the distributor.

3. The method of claim 1 further comprising assigning a second credit score to the distributor in response to the first recipient sharing the item of electronic content with a second recipient and the second recipient subsequently sharing the item with a third recipient, wherein the second credit score assigned to the distributor is based upon the first recipient sharing the item with the second recipient and the second recipient sharing the item with the third recipient.

4. The method of claim 1 wherein the item comprises at least one of an audiovisual presentation, a movie, a still image, an audio clip, an advertisement, or a news item.

5. The method of claim 1 wherein the content identifier categorizes the item by associating the item with one or more item types or categories including at least one of: an advertisement, a movie, an audiovisual presentation, a news item, a still image, an educational item, or an entertainment item.

6. The method of claim 1 wherein the reputation value is determined or calculated as a function of at least one of a number of recipients the distributor knows and a number of recipients who knows the distributor.

7. The method of claim 1 wherein the reputation value is determined or calculated using at least one of: a past distribution history for the distributor, a rating assigned to the distributor by one or more recipients, a type or category of electronic content that the distributor has previously shared with recipients, or any of various combinations thereof.

8. The method of claim 1 further comprising the distributor offering an Internet radio or television channel that includes links to a plurality of items of electronic content.

9. A computer program product for allocating credit based upon distribution of electronic content, the computer program product including a storage medium readable by a processing circuit and storing instructions for execution by the processing circuit for facilitating a method comprising:
distributing an item of electronic content from a distributor to a first recipient; generating a credit tracking message corresponding to the item of electronic content that includes a distributor identifier associated with the distributor; and
assigning a first credit score to the distributor using the credit tracking message.

10. The computer program product of claim 9 wherein distributing is performed by at least one of: transmitting a link to the item from a distributor to one or more recipients, transmitting the item, or a copy thereof, from the distributor to the one or more recipients, incorporating the link into an Internet web page, or incorporating the item, or a copy thereof, into the Internet web page; and the credit tracking message further includes one or more of: a content identifier associated with the item, one or more recipient identifiers associated with recipients to which the content is to be distributed, or a reputation value associated with the distributor; and wherein the credit score is based upon at least one of the content identifier associated with the item, a number of recipients to which the item is distributed, or the reputation value associated with the distributor.

11. The computer program product of claim 9 further comprising instructions for assigning a credit score to a first user representing a distributor in response to the first user sharing an item of electronic content with a set of second users representing recipients and the second set of users subsequently sharing the item with a third set of users, wherein the credit score assigned to the first user is based upon the first user sharing the item with the second set of users and the second set of users sharing the item with the third set of users.

12. The computer program product of claim 9 wherein the item comprises at least one of an audiovisual presentation, a movie, a still image, an audio clip, an advertisement, or a news item.

13. The computer program product of claim 9 wherein the content identifier categorizes the item by associating the item with one or more item types or categories including at least one of: an advertisement, a movie, an audiovisual presentation, a news item, a still image, an educational item, or an entertainment item.

14. The computer program product of claim 9 further including instructions for determining or calculating the reputation value as a function of a number of recipients the distributor knows, or a number of recipients who know the distributor, or both.

15. The computer program product of claim 9 further including instructions for determining or calculating the reputation value using at least one of: a past distribution history for the distributor, a rating assigned to the distributor by one or more recipients, a type or category of electronic content that the distributor has previously shared with recipients, or any of various combinations thereof.

16. The computer program product of claim 9 further comprising instructions for enabling the distributor to offer an Internet radio or television channel that includes links to a plurality of items of electronic content.

17. A system for allocating credit based upon distribution of electronic content, the system comprising:
a distribution server for distributing an item of electronic content from a distributor to a first recipient;
the distribution server including a mechanism for generating a credit tracking message corresponding to the item of electronic content that includes a distributor identifier associated with the distributor; and
an electronic credit tracking server, operably coupled to the distribution server, for assigning a first credit score to the distributor using the credit tracking message.

18. The system of claim 17 wherein the distribution server performs least one of: transmitting a link to the item from a distributor to one or more recipients, transmitting the item, or a copy thereof, from the distributor to the one or more recipients, incorporating the link into an Internet web page, or incorporating the item, or a copy thereof, into the Internet web page; and the credit tracking message further includes one or more of: a content identifier associated with the item, one or more recipient identifiers associated with recipients to which the content is to be distributed, or a reputation value associated with the distributor; and wherein the credit score is based upon at least one of the content identifier associated with the item, a number of recipients to which the item is distributed, or the reputation value associated with the distributor.

19. The system of claim 18 wherein the electronic credit tracking server assigns a credit score to a first user representing a distributor in response to the first user sharing an item of electronic content with a set of second users representing recipients and the second set of users subsequently sharing the item with a third set of users, wherein the credit score assigned to the first user is based upon the first user sharing the item with the second set of users and the second set of users sharing the item with the third set of users.

20. The system of claim 18 wherein each of a plurality of respective reputation values for each of a plurality of corresponding distributors are stored in the electronic credit tracking server or the distribution server or both.

21. The system of claim 18 wherein the electronic credit tracking server or the distribution server determines or calculates the reputation value as a function of a number of recipients the distributor knows, or a number of recipients who know the distributor, or both.

22. The system of claim 18 wherein the electronic credit tracking server or the distribution server determines or calculates the reputation value as a function of a past distribution history for the distributor, a rating assigned to the distributor by one or more recipients, a type or category of electronic content that the distributor has previously shared with recipients, or any of various combinations thereof.

23. The system of claim 18 wherein the distribution server implements an Internet radio or television channel for the distributor by providing links to a plurality of items of electronic content.
